(19) United States
(12) Patent Application Publication
(10) Pub. No.: US 2004/0230913 A1
(43) Pub. Date: Nov. 18, 2004

(54) Information terminal device for displaying user environment status on display screen

(75) Inventor: Hiroshi Moribe, Ota-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/844,511

(22) Filed: May 13, 2004

(30) Foreign Application Priority Data
May 14, 2003 (JP) 2003-135847

(51) Int. Cl. G09G 5/00

(52) U.S. Cl. 715/778

(57) ABSTRACT

An information terminal device allows the user to easily recognize the status of user environments that are set up on the information terminal device. In the information terminal device, a user environment controller prompts the user to register an object such as application software when the user environments are set up. After the user environments are set up, the user environment controller monitors the status of the object. If it is judged that the status of the object has undergone a change, then the user environment controller displays the status change on a display unit.

### BACKGROUND OF THE INVENTION

1. Field of the Invention

The present invention relates to an information terminal device such as a PC (personal computer) or the like which is capable of setting up one or more user environments, and a method of processing user environments with such an information terminal device.

2. Description of the Related Art

The popularity of information terminal devices such as PCs or the like is growing in the modern highly advanced information-intensive society.

However, many information terminal devices in actual use are in the hands of limited users who are familiar with those instruments. In reality, information terminal devices are not so popular among users who are not much knowledgeable about them.

Recently, a business enterprise has developed and sold information terminal devices that are targeted at potential customers among which the popularity of those information terminal devices has been low. One specific type of such information terminal devices is a family-oriented PC.

A family-oriented PC is a single PC that can be used by a plurality of users. The family-oriented PC sets up a plurality of user environments for the respective users and assigns buttons, referred to as family buttons, to the respective users. When either one of the family buttons is pressed, the family-oriented PC switches to the user environment corresponding to the pressed family button. Therefore, the family-oriented PC is advantageous in that the users can easily switch their respective user environments into action.

However, the proposed family-oriented PC does not assume that application software (hereinafter referred to as AP software) such as electronic mail software or the like is activated after a user has switched on its own user environment. If the user is a novice, then the user may find it troublesome to activate the AP software after having switched on its own user environment. Furthermore, if there are many AP software programs available on the family-oriented PC, then it is quite time-consuming for the user to locate a desired one of those AP software programs.

In view of the above problems, some recent PCs incorporate a function called a launcher. The launcher function is a function to display a list of AP software program icons on the PC display screen, and activate one of the AP software programs when the icon corresponding to that AP software program is clicked. The launcher function allows the user to find and activate the desired AP software program quickly.

However, the launcher function merely arranges and displays a list of AP software programs that are set up in the user environment by the user. With the PC using the launcher function, the user is unable to recognize the status of the user environment.

Since the user cannot recognize the status of the user environment, the user may possibly tend to make needless control actions or make control actions in a sequence different from a desired sequence, resulting in other problems.

For example, if the user does not know if there has been incoming electronic mail or not, the user needs to activate the electronic mail software to confirm whether incoming electronic mail has arrived or not. If it is confirmed that no electronic mail has arrived, then the process of activating the electronic mail software becomes useless. If the user is a beginner, then it is possible for the user to make a mistake by activating other AP software instead of the electronic mail software.

When the PC with the launcher function is shared by a plurality of users, a user who is currently using the PC is unable to recognize the user environments of the other users.

For example, it is assumed that when a user is going to turn off the power supply of the PC, another user is still in the process of using the PC (e.g., in the process of producing a document file with document producing software). Inasmuch as the user who is going to turn off the power supply is unable to recognize the user environment of the other user, the power supply of the PC is forcibly turned off irrespectively of whether the document file being produced by the other user has been saved or not, possibly wasting the other user's operation.

### SUMMARY OF THE INVENTION

It is therefore an object of the present invention to provide an information terminal device which is capable of allowing a user to easily recognize the status of a user environment, and a method of processing user environments with an information terminal device.

According to the present invention, to achieve the above object, a control means monitors a status of an object specified by specific information for specifying a user environment, and displays a change in the status on a display means if the monitored state has undergone a change.

Therefore, the user can immediately recognize a status change in its own user environment, and may switch between user environments or activate or operate AP software that has been registered as an object, according to the status change.

The control means registers the specific information in a hierarchical form. If more than one user uses the information terminal device, therefore, information for identifying the users and information of AP software serving as objects specified by the specific information can be registered in a hierarchical form as the specific information for specifying user environments.

The control means displays, on the display means, not only a status change of the object specified by the specific information for specifying the user environment of a user who is currently using the information terminal device, but also a status change of the object specified by the specific information for specifying the user environment of another user who is not currently using the information terminal device.

Consequently, the user can also recognize a status change even when the user environment of the other user who is not currently using the information terminal device has undergone a status change. For example, if the information terminal device is used by more than one user, then a user can recognize a status change of an object specified by specific information for specifying the user environment of another user while the user is using the information terminal device in its own user environment.

The control means controls an operation means to switch between user environments and activate or operate AP software, based on commands from the user.

Therefore, the user can switch between user environments and activate or operate AP software that has been registered as a specified object, according to commands that the user itself has entered.

For example, if the information terminal device is used by more than one user, then a user can switch between users according to any of settings given as indicated in (1) through (3) below.

(1) The user who is currently using the information terminal device remains logged on, and the user switches to another user.

(2) The user who is currently using the information terminal device is logged off, and the user switches to another user.

(3) The user who is currently using the information terminal device is logged off.

If there is a status change of AP software serving as an object specified by specific information for specifying the user environment of a user, then the user can automatically activate that AP software.

When a mark identifying a user environment is clicked on an image displayed on the display means, the control means controls the operation means to switch to the clicked user environment. When a mark indicative of AP software that is registered as an object specified in user environments is clicked, the control means controls the operation means to activate or operate the clicked AP software.

Therefore, the user can simply effect switching between user environments which has heretofore been performed on an OS (Operating System), and can simply activate or operate AP software that is registered as an object specified in user environments. If the number of users who use the information terminal device is increased and the user environment of an added user is to be newly set up, a mark for identifying the user environment to be newly set up is displayed on the display means. Therefore, the information terminal device is compatible with an increase in the number of users thereof.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of an information terminal device according to an embodiment of the present invention;

FIG. 2 is a flowchart of a method of processing user environments with the information terminal device shown in FIG. 1;

FIG. 3 is a view showing a displayed image on a display unit of the information terminal device shown in FIG. 1;

FIG. 4 is a view showing a displayed image on the display unit which has switched from the displayed image shown in FIG. 3;

FIG. 5 is a view showing another displayed image on the display unit which has switched from the displayed image shown in FIG. 3; and

FIG. 6 is a diagram illustrative of specific details of the method of processing user environments with the information terminal device shown in FIG. 1.

### DESCRIPTION OF THE PREFERRED EMBODIMENTS

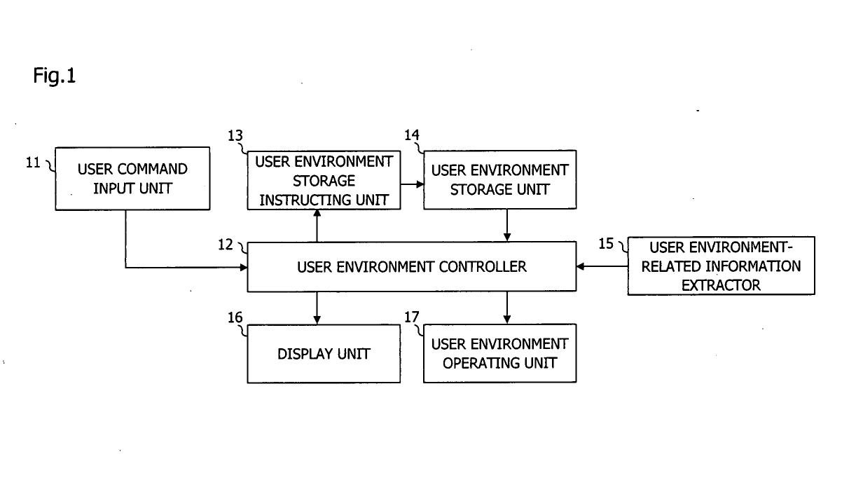

As shown in FIG. 1, an information terminal device according to an embodiment of the present invention has user command input unit 11, user environment controller 12, user environment storage instructing unit 13, user environment storage unit 14, user environment-related information extractor 15, display unit 16, and user environment operating unit 17.

User command input unit 11 comprises a keyboard, a mouse, etc. for entering various commands from the user. The user uses user command input unit 11 to move an icon on the display screen of display unit 16, click an icon where the icon is moved to, or enter characters and symbols in certain positions on the display screen of display unit 16.

When a user environment is set up, user environment controller 12 prompts the user to register a hierarchical form of specific information for specifying the user environments via user command input unit 11.

For example, user environment controller 12 registers, as specific information for specifying user environments, identification information (user names, etc.) for identifying users, and then information about AP software (electronic mail software, spreadsheet software, homepage browsing software, etc.) to be set up by user environments and data (such as homepages to be browsed by homepage browsing software, etc.) that are processed by AP software.

User environment storage instructing unit 13 instructs user environment storage unit 14 to store specific information for specifying user environments which has been registered by users.

User environment storage unit 14 stores specific information for specifying user environments when instructed by user environment storage instructing unit 13.

User environment-related information extractor 15 extracts information related to objects set by the specific information for specifying user environments which has been stored in user environment storage unit 14, and sends the extracted information to user environment controller 12. User environment-related information extractor 15 extracts the related information from a component (not shown) in the information terminal device. User environment-related information extractor 15 can also extract the related information from another information terminal device or a server or the like (not shown) which is connected via a network (not shown) to the information terminal device shown in FIG. 1.

For example, if an object set by the specific information for specifying user environments is electronic mail software, then user environment-related information extractor 15 extracts incoming information of electronic mail that has arrived via the electronic mail software as the related information.

User environment controller 12 displays registered contents of the specific information for specifying user environments which has been stored in user environment storage unit 14, on display unit 16. User environment controller 12 also monitors whether the object set by the specific information for specifying user environments has undergone a status change or not, based on the related information extracted by user environment-related information extractor 15. If there is a status change, then user environment controller 12 displays the status change on display unit 16.

User environment controller 12 controls user environment operating unit 17 to switch between user environments and activate or operate AP software which is the object set by the specific information for specifying user environments, based on commands that the user has entered into user command input unit 11.

Display unit 16 comprises a display or the like for displaying various items of information. Based on instructions from user environment controller 12, display unit 16 displays registered contents of user environments, and when the object set by the specific information for specifying user environments has undergone a status change, displays such status change.

User environment operating unit 17 switches between user environments and activates or operates AP software which is the object set by the specific information for specifying user environments, based on instructions from user environment controller 12.

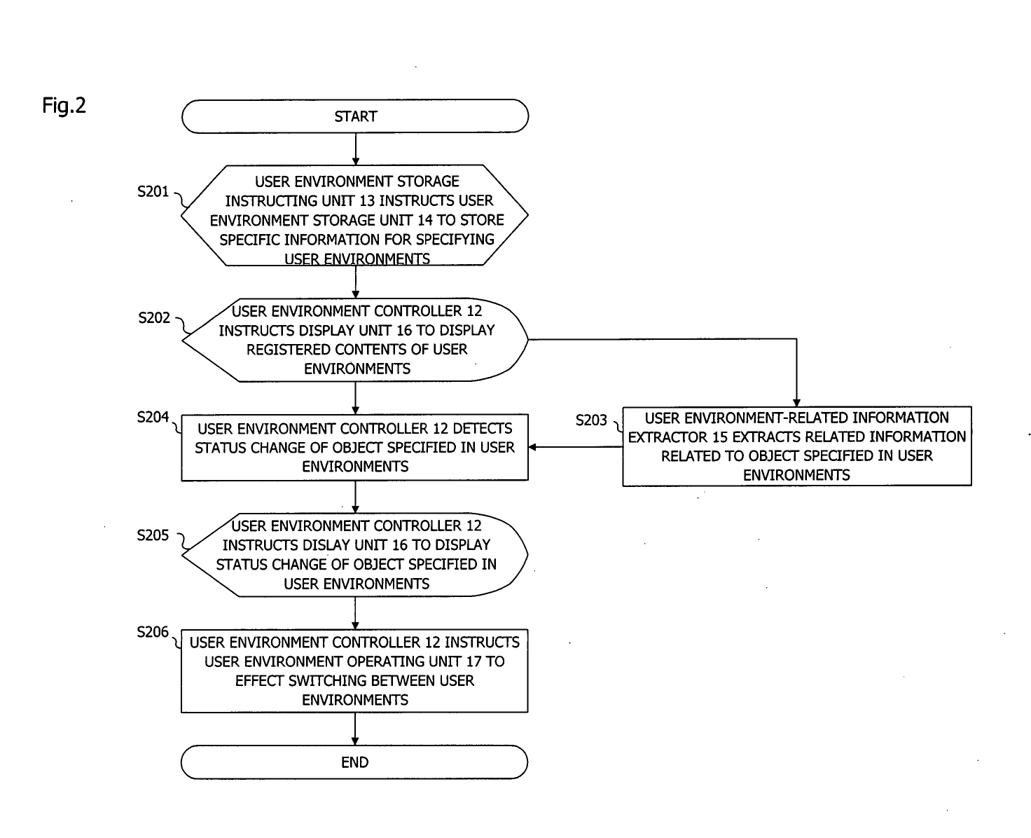

Operation of the information terminal device shown in FIG. 1 for displaying a status of user environments will be described below with reference to a flowchart shown in FIG. 2.

In step 201, when a user environment is set up, user environment controller 12 prompts the user to register a hierarchical form of specific information for specifying the user environments via user command input unit 11. Then, user environment storage instructing unit 13 stores the hierarchical form of specific information for specifying the user environments, which the user has registered, in user environment storage unit 14.

For example, if the information terminal device is used by more than one user, then user environment controller 12 sets up user environments for the respective users who use the information terminal device. User environment controller 12 registers, as specific information for specifying user environments, identification information (user names, etc.) for identifying users, and then information about AP software (electronic mail software, spreadsheet software, homepage browsing software, etc.) to be set up by user environments and data (such as homepages to be browsed by homepage browsing software, etc.) that are processed by AP software.

In step 202, user environment controller 12 displays registered contents of the specific information for specifying user environments which has been stored in user environment storage unit 14, on display unit 16.

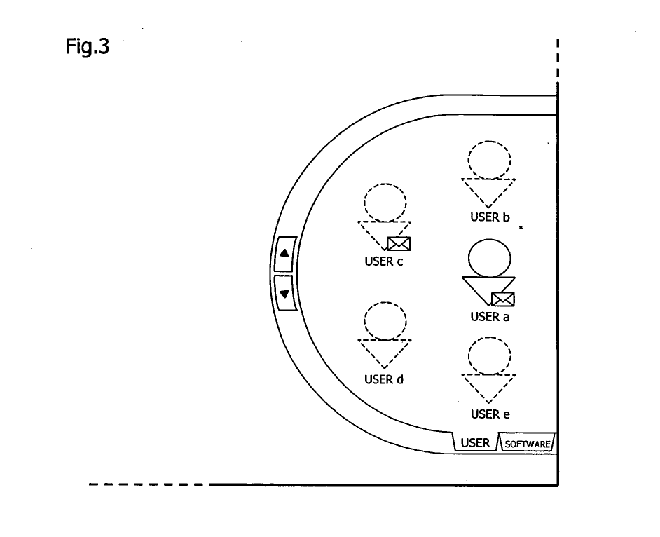

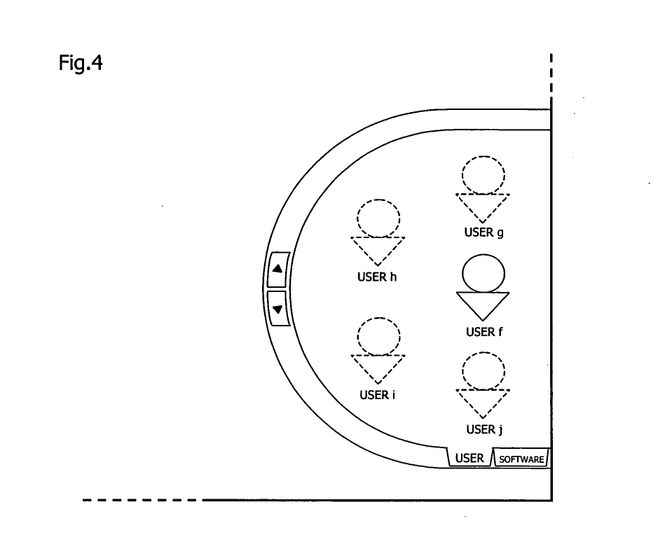

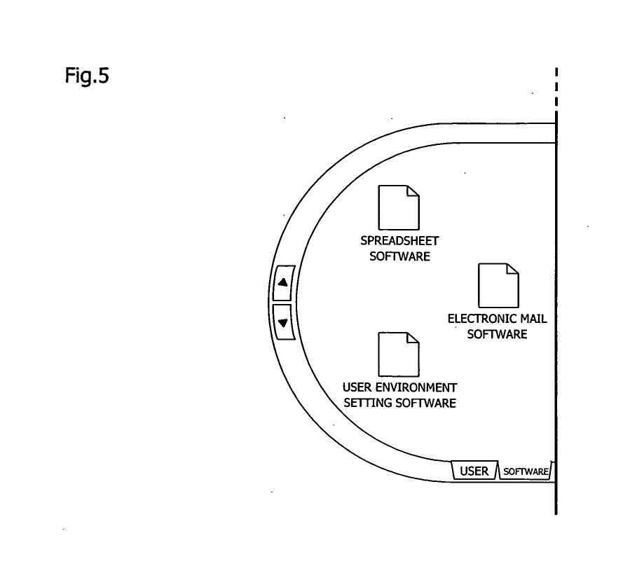

For example, if the information terminal device is used by more than one user, then, as shown in FIG. 3, user environment controller 12 displays, on display unit 16, user marks which identify the user environments of users (users a through e in FIG. 3) who use the information terminal device. When a left tab represented by triangle marks shown in FIG. 3 is clicked, user environment controller 12 displays, on display unit 16, user marks which identify the user environments of users (users f through j in FIG. 4) belonging to another user group, as shown in FIG. 4. When a lower tab represented by “SOFTWARE” in FIG. 3 or FIG. 4 is clicked, user environment controller 12 displays, on display unit 16, marks representative of AP software programs (a spreadsheet software program, an electronic mail software program, and a user environment setting software program in FIG. 5) that have been registered as objects by the users who are using the information terminal device, as shown in FIG. 5.

In step 203, user environment-related information extractor 15 refers to the specific information for specifying the user environments which has been stored in user environment storage unit 14, extracts information related to an object specified by the specific information, and sends the extracted related information to user environment controller 12.

In step 204, user environment controller 12 detects whether the object specified by the specific information for specifying the user environments which has been stored in user environment storage unit 14 has undergone a status change or not. If the object specified by the specific information has undergone a status change, then user environment controller 12 displays the status change on display unit 16 in step 205.

For example, it is assumed that more than one user uses the information terminal device, some of the users register electronic mail software as a specified object, and there has been incoming electronic mail addressed to the users. As shown in FIG. 3, user environment controller 12 displays, on display unit 16, mail marks indicating that there has been incoming electronic mail addressed to the relevant users (users a, c in FIG. 3). According to the present embodiment, therefore, when not only the object specified by the specific information for specifying the user environment of user a who is currently using the information terminal device, but also the object specified by the specific information for specifying the user environment of user c who is not currently using the information terminal device, has undergone a status change, marks indicative of the status change are displayed on display unit 16.

Thereafter, in step 206, user environment controller 12 controls user environment operating unit 17 to switch between user environments and activate or operate AP software based on commands that the user has entered into user command input unit 11.

For example, if the information terminal device is used by more than one user, then when either one of the displayed user marks shown in FIG. 3 or 4 is clicked, user environment controller 12 controls user environment operating unit 17 to switch to the corresponding user environment. When either one of the displayed marks of the AP software programs shown in FIG. 5 is clicked, user environment controller 12 controls user environment operating unit 17 to activate or operate the corresponding AP software program.

The user is able to enter, through user command input unit 11, detailed conditions for the above processing sequence in user environment operating unit 17 on any one of the displayed images shown in FIGS. 3 through or other displayed images. Depending on a command entered by the user, user environment controller 12 controls user environment operating unit 17 to execute the following processing operation:

For example, user environment controller 12 can control user environment operating unit 17 to switch between users according to any of settings given as indicated in (1) through (3) below.

(1) The user who is currently using the information terminal device remains logged on, and the user switches to another user.

(2) The user who is currently using the information terminal device is logged off, and the user switches to another user.

(3) The user who is currently using the information terminal device is logged off.

If user environment controller 12 detects a status change of the AP software as the object specified by the specific information for specifying the user environment, then user environment controller 12 may automatically allow user environment operating unit 17 to activate that AP software.

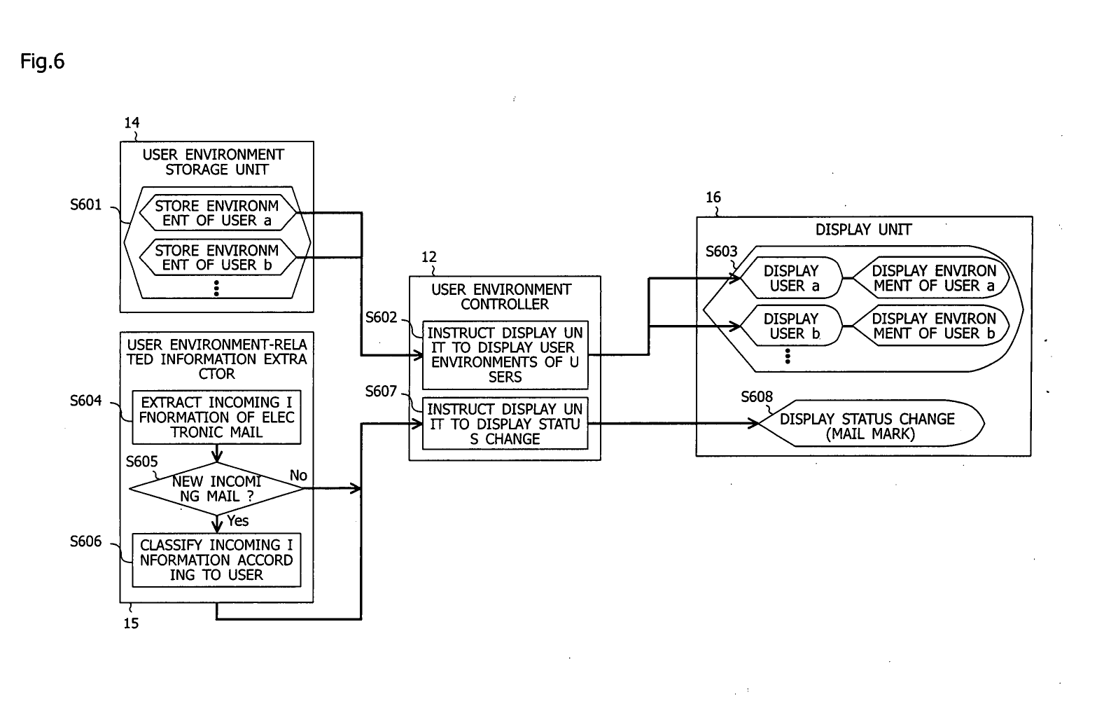

Operation of the information terminal device shown in FIG. 1 for displaying a status of user environments will be described in specific detail below with reference to a flowchart shown in FIG. 6. It is assumed in FIG. 6 that a plurality of users (users a, b, . . . in FIG. 6) use the information terminal device.

In step 601, specific information for specifying the user environments set up for the respective users (users a, b, . . . in FIG. 6) is stored in advance in user environment storage unit 14. Specific information representing that an object specified by the specific information for specifying the user environments set up for the respective users is electronic mail software is also stored in advance in user environment storage unit 14.

In steps 602, 603, user environment controller 12 displays registered contents of the specific information for specifying the user environments for the users which has been stored in user environment storage unit 14, on display unit 16. For example, the displayed images (see FIGS. 3 and 4) of user marks of the respective users and the displayed image (see FIG. 5) of marks of electronic mail software that serves as the object specified by the specific information for specifying the user environments set up for the respective users, may be switched and displayed on display unit 16.

In step 604, user environment-related information extractor 15 extracts incoming information indicative of whether there has been incoming mail addressed to the users or not, as related information related to the electronic mail software that serves as the object specified by the specific information for specifying the user environments set up for the respective users.

In step 605, user environment-related information extractor 15 determines whether there has been incoming electronic mail addressed to any one of the users or not, based on the extracted incoming information. If user environment-related information extractor 15 decides that there has been incoming mail addressed to either one of the users in step 605, then user environment-related information extractor 15 classifies the incoming information according to users thereby to recognize which user the incoming electronic mail is addressed to, and sends the classified incoming information to user environment controller 12. If there has been no incoming mail addressed to any one of the users, then user environment-related information extractor 15 indicates information to that effect to user environment controller 12.

Thereafter, in steps 607, 608, if user environment controller 12 detects incoming electronic mail addressed to either one of the users based on the notification from user environment-related information extractor 15, then user environment controller 12 displays a mail mark indicating that electronic mail has arrived at the user on display unit 16. For example, a mail mark may be displayed on the displayed user mark of the user, as shown in FIG. 3.

According to the present embodiment, as described above, user environment controller 12 monitors the status of an object specified by the specific information for specifying user environments. If the object has undergone a status change, then user environment controller 12 displays the status change on display unit 16.

Therefore, the user can immediately recognize the status change in the user environments, and may switch between the user environments or activate or operate the AP software that has been registered as the object, according to the status change.

According to the present embodiment, user environment controller 12 registers a hierarchical form of specific information for specifying user environments.

For example, if the information terminal device is used by more than one user, then user environment controller 12 registers, as specific information for specifying user environments, identification information (user names, etc.) for identifying users, and information about an object specified by the specific information for specifying user environments (AP software and data processed by AP software).

According to the present embodiment, when not only the object specified by the specific information for specifying the user environment of a user who is currently using the information terminal device, but also the object specified by the specific information for specifying the user environment of another user who is not currently using the information terminal device, has undergone a status change, user environment controller 12 displays such a status change on display unit 16.

Consequently, the user can immediately recognize a status change even when the user environment of the other user who is not currently using the information terminal device has undergone such a status change. For example, if the information terminal device is used by more than one user, then a user can recognize a status change of an object specified by specific information for specifying the user environment of another user (e.g., the arrival of incoming electronic mail addressed to the other user) while the user is using the information terminal device in its own user environment.

According to the present embodiment, furthermore, user environment controller 12 controls user environment operating unit 17 to switch between user environments and activate or operate AP software, based on commands that the user has entered into user command input unit 11.

Therefore, the user can switch between user environments and activate or operate AP software that has been registered as a specified object, according to commands that the user itself has entered.

For example, if the information terminal device is used by more than one user, then a user can switch between users according to any of settings given as indicated in (1) through (3) below.

(1) The user who is currently using the information terminal device remains logged on, and the user switches to another user.

(2) The user who is currently using the information terminal device is logged off, and the user switches to another user.

(3) The user who is currently using the information terminal device is logged off.

If there is a status change of AP software serving as an object specified by specific information for specifying the user environment of a user, then the user can automatically activate that AP software.

According to the present embodiment, furthermore, when a mark identifying a user environment is clicked on a desktop image displayed on display unit 16, user environment controller 12 controls user environment operating unit 17 to switch to the clicked user environment. When a mark indicative of AP software that is registered as an object specified in user environments is clicked, user environment controller 12 controls user environment operating unit 17 to activate or operate the clicked AP software.

Therefore, the user can simply switch between user environments, and can simply activate or operate AP software that is registered as an object specified in user environments. If the number of users who use the information terminal device is increased and the user environment of an added user is to be newly set up, a mark for identifying the user environment to be newly set up is displayed on display unit 16. Therefore, the information terminal device is compatible with an increase in the number of users thereof.

In the present embodiment, the information terminal device is used by more than one user. However, the present invention is not limited to such an application. For example, the principles of the present invention are also applicable to a mode of usage in which a single user uses the information terminal device in different user environments which can be switched from one to another depending on the purpose (for business or pleasure) for which the information terminal device is used. In this case, the user sets up user environments for respective purposes for which the information terminal device is used, and registers specific information for each of the user environments when that user environment is set up. The principles of the present invention are also applicable to another mode of usage in which a single user uses more than one information terminal device interconnected by a network. In this case, the user sets up user environments for the respective information terminal devices interconnected by the network, and registers specific information for each of the user environments when that user environment is set up.

In the present embodiment, electronic mail software is registered as an object specified in user environments, and when incoming electronic mail has arrived, a status change is detected as occurring in the object. However, the present invention is not limited to such an application. For example, if homepage browsing software is registered as an object specified in user environments, and any optional homepage on the Internet is registered which can be browsed by the homepage browsing software, then user environment controller 12 may detect a status change in the object when that homepage is updated. Furthermore, if software for viewing, recording, and playing back a TV broadcasting/Internet broadcasting program is registered as an object specified in user environments, and any optional program that can be viewed, recorded, and played back is registered, then user environment controller 12 may detect a status change in the object when that program starts being broadcast.

While preferred embodiments of the present invention have been described using specific terms, such description is for illustrative purposes only, and it is to be understood that changes and variations may be made without departing from the spirit or scope of the following claims.

What is claimed is:

1. An information terminal device for setting up at least one user environment thereon, comprising:
display means for displaying a plurality of items of information on a display screen thereof; and
control means for prompting a user to register specific information for specifying a user environment when the user environment is set up, monitoring a status of an object specified by the specific information, and displaying a change in the status on the display screen of said display means if the monitored state has undergone such a change.

2. An information terminal device according to claim 1, wherein said control means prompts the user to register said specific information as a hierarchical form when said user environment is set up.

3. An information terminal device according to claim 1, wherein said control means displays not only a change in the status of the object specified by the specific information for specifying the user environment of a user who is currently using the information terminal, but also a change in the status of the object specified by the specific information for specifying the user environment of another user who is not currently using the information terminal.

4. An information terminal device according to claim 1, further comprising:
operation means for switching to the user environment;
wherein said control means displays a mark for identifying the user environment on the display screen of said display means, and controlling said operation means to switch to the user environment when the mark for identifying said user environment is clicked.

5. An information terminal device according to claim 4, wherein said control means sets up user environments of more than one user who uses the information terminal device, and, when said control means is to control said operation means to switch between the user environments, said control means controls said operation means to switch between the user environments while keeping a user who is currently using the information terminal device logged on.

6. An information terminal device according to claim 4, wherein said control means sets up user environments of more than one user who uses the information terminal device, and, when said control means is to control said operation means to switch between the user environments, said control means controls said operation means to switch between the user environments while logging off a user who is currently using the information terminal device.

7. An information terminal device according to claim 4, wherein said control means sets up user environments of more than one user who uses the information terminal device, and, when said control means is to control said operation means to switch between the user environments, said control means logs off a user who is currently using the information terminal device.

8. An information terminal device according to claim 1, further comprising:
operation means for activating or operating software;
wherein if software is specified as an object by the specific information for specifying the user environment, said control means displays a mark representing the software on the display screen of said display means, and if said mark is clicked, said control means controls said operation means to activate or operate the clicked software.

9. An information terminal device according to claim 1, further comprising:
operation means for activating or operating software;
wherein if software is specified as an object by the specific information for specifying the user environment and undergoes a status change, said control means automatically controls said operation means to activate or operate the software.

10. An information terminal device according to claim 1, wherein said control means displays a mark identifying said user environment and a mark indicating a status change of the object specified by the specific information, on the display screen of said display means.

11. A method of processing a user environment with an information terminal device for setting up at least one user environment thereon, comprising the steps of:
prompting a user to register specific information for specifying the user environment when the user environment is set up;
monitoring a state of an object specified by the specific information; and
displaying a change in the status on a display screen if the monitored state has undergone a change.

12. A method according to claim 11, wherein said step of registering specific information prompts the user to register said specific information as a hierarchical form when said user environment is set up.

13. A method according to claim 11, wherein said step of displaying a change in the status displays not only a change in the status of the object specified by the specific information for specifying the user environment of a user who is currently using the information terminal, but also a change in the status of the object specified by the specific information for specifying the user environment of another user who is not currently using the information terminal.

14. A method according to claim 11, further comprising the steps of:
displaying a mark for identifying the user environment which is set up on the display screen; and
switching to the user environment when the mark for identifying said user environment is clicked.

15. A method according to claim 14, wherein user environments of more than one user who uses the information terminal device are setup, and when the user environments are to be switched from one to another, said step of switching to the user environment switches between the user environments while keeping a user who is currently using the information terminal device logged on.

16. A method according to claim 14, wherein user environments of more than one user who uses the information terminal device are setup, and when the user environments are to be switched from one to another, said step of switching to the user environment switches between the user environments while logging off a user who is currently using the information terminal device.

17. A method according to claim 14, wherein user environments of more than one user who uses the information terminal device are setup, and when the user environments are to be switched from one to another, said step of switching to the user environment logs off a user who is currently using the information terminal device.

18. A method according to claim 11, further comprising the steps of:
if software is specified as an object by the specific information for specifying the user environment which is registered in said step of registering specific information, displaying a mark representing the software on the display screen; and
if said mark is clicked, activating or operating the clicked software.

19. A method according to claim 11, further comprising the step of:
if software is specified as an object by the specific information for specifying the user environment which is registered in said step of registering specific information and undergoes a status change as a result of said step of monitoring a state of an object specified by the specific information, automatically activating or operating the clicked software.

20. A method according to claim 11, wherein said step of displaying a change in the status displays a mark identifying said user environment which is set up and a mark indicating a status change of the object specified by the specific information, on the display screen.
